(19) United States
(12) Patent Application Publication
(10) Pub. No.: US 2026/0169899 A1
(43) Pub. Date: Jun. 18, 2026

(54) FUNCTIONAL TESTING ASSISTANCE SYSTEM

(71) Applicant: Walmart Apollo, LLC, Bentonville, AR (US)

(72) Inventors: Cornel Dutta, Bangalore (IN); Satyanarayana Murthy Viswanatha, Bengaluru (IN); Venkata Subramanian Jayaraman, Chennai (IN); Jitendra Kumar, Kada Agrahara (IN)

(21) Appl. No.: 18/984,372

(22) Filed: Dec. 17, 2024

(51) Int. Cl. G06F 11/3668

(52) U.S. Cl. CPC G06F 11/368; G06F 11/3684; G06F 11/3692

(57) ABSTRACT

Example implementations relate to automatically generating and updating functional tests for software applications. A first version of requirement information for a software application is received and segmented into respective portions. An input to a trained model is generated based on the respective portions. One or more functional tests that determine whether the software application satisfies the first version of the requirement information are generated. Embeddings associated with the one or more functional tests are generated. In response to receiving an updated version of the requirement information for the software application: one or more semantic differences between the versions of the requirement information are identified, a modified input to the trained model is generated based on the semantic differences and the embeddings, one or more updated functional tests are generated to determine whether the software application satisfies the updated version of the requirement information.

### TECHNICAL FIELD

This application relates generally to automated generation of functional tests, and more particularly, the use of generative models to generate functional tests.

### BACKGROUND

Individual components of a software development project are validated via functional testing. Functional tests are used to assess the behavior of individual functions within the software development project and are important to software development practices, such as Test-Driven Development (TDD) and Behavior-Driven Development (BDD), and for ascertaining the quality of applications on Continuous Integration/Continuous Deployment (CI/CD) pipelines. However, writing, automating and maintaining of functional tests is labor-intensive and time-consuming for developers, and detracts developers from feature development of the software projects.

Further, achieving complete test coverage is difficult, as critical edge cases may often be missed. Ongoing software changes may necessitate frequent updates to suites of functional tests, and increase the maintenance burden of the functional tests. Inefficient testing processes may delay feature rollouts, impact the quality of the software product, and potentially increase the long-term costs of software maintenance. Additionally, new developers may face a steep learning curve in contributing to test automation effectively. In some instances, subjective bias in test design can lead to neglecting essential but less obvious test cases.

### BRIEF DESCRIPTION OF THE DRAWINGS

Various examples will be described below with reference to the following figures.

FIG. 1 depicts an example system for functional testing, in accordance with some embodiments.

FIG. 2 is a block diagram of an example functional testing assistance module, in accordance with some embodiments.

FIG. 3 is a flowchart illustrating a functional test generation and updating method, in accordance with some embodiments.

FIG. 4 depicts an example system with machine readable storage media that include instructions to perform functional testing generation and updating, in accordance with some embodiments.

FIG. 5 depicts an example functional testing assistance computing device in accordance with some embodiments.

FIG. 6 depicts an example deep neural network (DNN), in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” describes such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions is disclosed. The processor reads the instructions to receive a first version of requirement information for a software application and segment the first version of the requirement information into respective portions. The processor further reads the instructions to generate an input to a trained model based on the respective portions and receive and process one or more outputs from the trained model to generate one or more functional tests that determine whether the software application satisfies the first version of the requirement information specified in the respective portions. The processor reads the instructions to generate embeddings associated with the one or more functional tests. In response to receiving an updated version of the requirement information for the software application, the processor identifies one or more semantic differences between the updated version of the requirement information and the first version of the requirement information and generates a modified input to the trained model based on the semantic differences and the embeddings associated with the one or more functional tests. The processor further reads the instructions to receive and processes one or more modified outputs from the trained model to generate one or more updated functional tests that determine whether the software application satisfies the updated version of the requirement information.

In various embodiments, a computer-implemented method is disclosed. The computer-implemented method includes the steps of receiving a first version of requirement information for a software application and segmenting the first version of the requirement information into respective portions. The computer-implemented method further includes the steps of generating an input to a trained model based on the respective portions and receiving and processing one or more outputs from the trained model to generate one or more functional tests that determine whether the software application satisfies the first version of the requirement information specified in the respective portions. The computer-implemented method further includes a step of generating embeddings associated with the one or more functional tests. The computer-implemented method further includes steps of, in response to receiving an updated version of the requirement information for the software application, identifying one or more semantic differences between the updated version of the requirement information and the first version of the requirement information, generating a modified input to the trained model based on the semantic differences and the embeddings associated with the one or more functional tests, and receiving and processing one or more modified outputs from the trained model to generate one or more updated functional tests that determine whether the software application satisfies the updated version of the requirement information.

In various embodiments, a non-transitory computer-readable medium having instructions stored thereon is disclosed. The instructions, when executed by at least one processor, cause at least one device to perform operations including receiving a first version of requirement information for a software application, segmenting the first version of the requirement information into respective portions, generating an input to a trained model based on the respective portions, receiving and processing one or more outputs from the trained model to generate one or more functional tests that determine whether the software application satisfies the first version of the requirement information specified in the respective portions, and generating embeddings associated with the one or more functional tests. In response to receiving an updated version of the requirement information for the software application, the instructions cause the at least one device to perform operations including identifying one or more semantic differences between the updated version of the requirement information and the first version of the requirement information, generating a modified input to the trained model based on the semantic differences and the embeddings associated with the one or more functional tests, and receiving and processing one or more modified outputs from the trained model to generate one or more updated functional tests that determine whether the software application satisfies the updated version of the requirement information.

Furthermore, in the following, various embodiments are described with respect to methods and systems for automatically generating and/or updating functional tests for a software application. In various embodiments, a functional testing assistance system described herein leverages generative models (e.g., generative AI models) to automate the generation and updating of functional tests. By automatically ingesting API documentation and generating the necessary tests, the functional testing assistance system reduces the manual effort of test creation, ensuring more thorough test coverage and increasing the pace of the testing process to match software development. As further described below, the functional testing assistance system offers a comprehensive solution by providing ready-to-use functional test automation frameworks integrated with reporting platforms of an entity (e.g., an ecommerce environment, an ecommerce entity, or an ecommerce platform) and/or conforming to the entity's software deployment practices and configurations. The functional testing assistance system may reduce or eliminate the need for developers to spend time researching and building new testing frameworks. Further, a functional testing assistance system may include workflow orchestration capabilities to automate functional testing and/or manage reporting and data generated during the automated testing.

In some embodiments, systems and methods for generating and/or updating functional tests for a software application includes one or more trained large language models (LLMs). The trained LLMs may include one or more models, such as tuned instances of GPT-3.5-turbo, GPT-4, and CodeLlama.

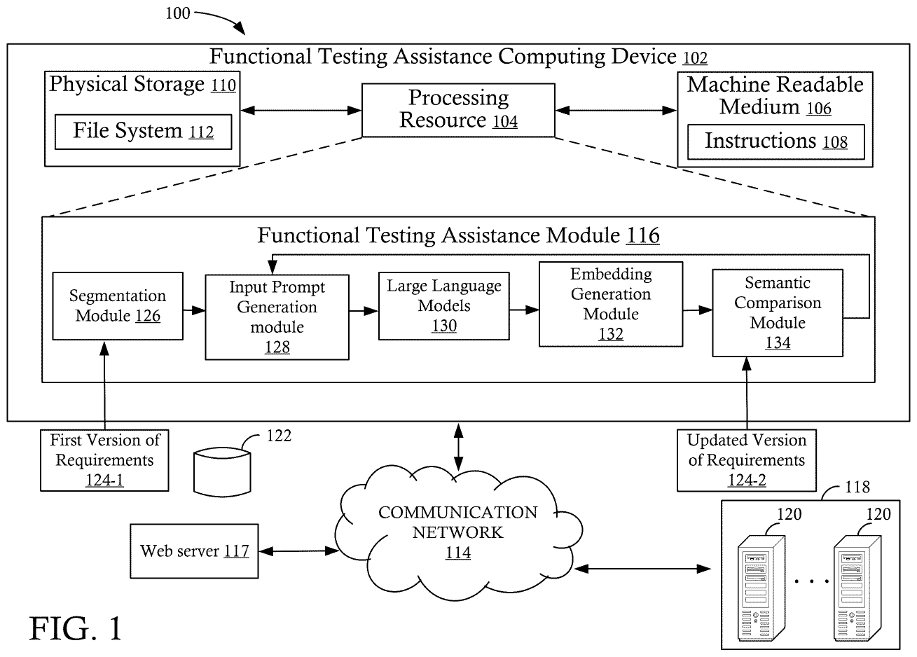

FIG. 1 depicts an example system 100 that provides automated assistance in generating and updating functional tests, in accordance with some embodiments. The system 100 includes a functional testing assistance computing device 102 that provides automated assistance in generating and updating functional tests. The functional testing assistance computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The functional testing assistance computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource. The functional test assistance system 100 described herein may enable developers to review, update, and/or customize functional test frameworks and tests within their integrated development environment (IDE) without the need for context switching. The functional test assistance system generates functional test automation frameworks that can be integrated with existing tools and processes of a network environment (e.g., an ecommerce platform, an ecommerce internal reporting platform, ecommerce deployment practices and configurations, etc.).

The processing resource 104 may execute instructions 108 (i.e., programming or software code) stored on machine-readable medium 106 to perform functions of the functional testing assistance computing device 102, such as generating and updating functional tests. The instructions 108 may include instructions for implementing one or more models. In some embodiments, and as will be further described below, the functional testing assistance computing device 102 may execute one or more models, processes, or algorithms, such as a machine learning model, deep learning model, statistical model, etc., (e.g., as implemented as machine-readable instructions) to generate and/or update functional tests for a software application.

The functional testing assistance computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the functional testing assistance computing device 102. In some implementations, physical storage 110 may be accessed as a block storage device.

In some cases, the functional testing assistance computing device 102 may also include a local file system 112 that may be implemented as a layer on top of the physical storage 110. For example, an operating system may be executing on the functional testing assistance computing device 102 (by virtue of the processing resource 104 executing certain instructions 108 related to the operating system) and the operating system may provide a file system 112 to store data on the physical storage 110.

The network 114 may include a plurality of devices or systems in communication with the functional testing assistance computing device 102 over one or more network channels, illustrated as a network cloud. For example, in various embodiments, the functional testing assistance computing device 102 may be in communication with a web server 117, a cloud-based engine 118 including one or more processing devices 120 that may be provisioned for use, a database 122, a workstation 124, and/or any other suitable system or device. The functional testing assistance computing device 102 may similarly be in communication, either directly or indirectly, with one or more user computing devices operatively coupled over the network 114. The other computing systems may be similar to the functional testing assistance computing device 102, and may each include at least a processing resource and a machine-readable medium.

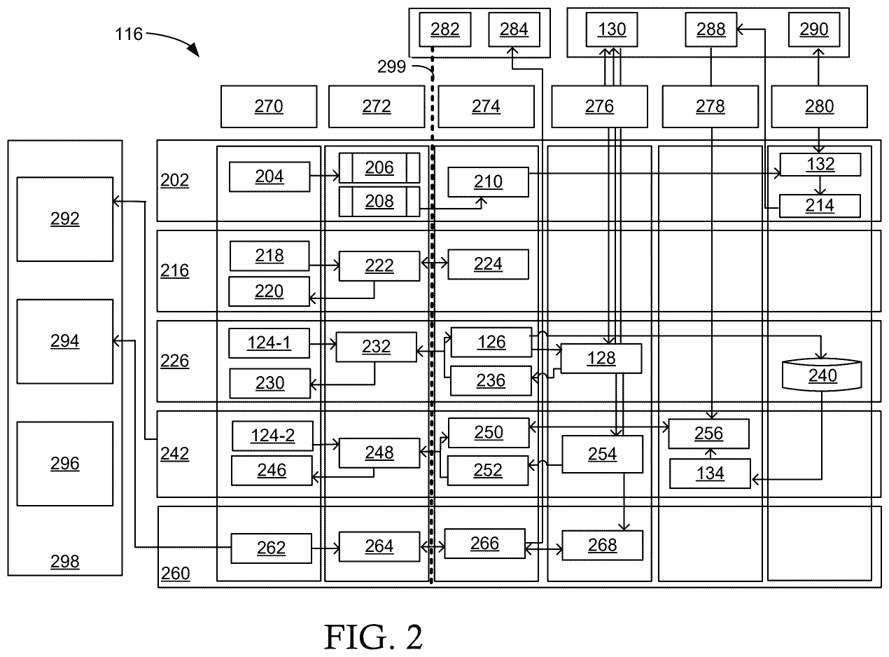

The functional testing assistance module 116, described in detail with reference to FIG. 2, receives a first version of requirements 124-1 (also referred to as an input 124-1), provided to a segmentation module 126 (also referred to as a pre-processing component 126). An output of the segmentation module 126 is provided to an LLM prompting module 128, which generates an input (e.g., a prompt) to a trained generative model, such as LLMs 130. The output from the trained generative model can generate functional tests, from which one or more embeddings are generated by an embedding generation module 132. An updated version of the requirements 124-2 (also referred to as input 124-2, or updated input 124-2) is provided to a semantic comparison module 134. The output from the semantic comparison module 134 can generate an updated prompt as an updated input to the trained generative model. The trained generative model then generates an updated functional test.

FIG. 2 is an example functional testing assistance module 116 of the functional testing assistance system 100 shown in FIG. 1, in accordance with some embodiments.

FIG. 2 illustrates various internal modules, described in greater detail below, of the functional testing assistance module 116 as horizontal boxes (e.g., a codebase change detection and embedding module 202, a functional test framework generation component 216, a functional test generation module 226, a functional test update component 242, and a workflow orchestration component 260), while vertical columns illustrate different roles performed by each component of the functional testing assistance module 116.

As described in greater detail below, the functional testing assistance module 116 may access a local codebase 270 to obtain relevant input information (e.g., stored locally in the local codebase 270 and/or retrieved externally based on linking information provided in the local codebase 270) and to provide (e.g., store) output data generated by one or more other internal modules of the functional testing assistance module 116. The components (e.g., a data folder 204, a directory structure 220, a data folder 230 etc.) depicted vertically below the local codebase 270 correspond to various functionalities, data structures, and/or data associated with the local codebase 270. For example, in some embodiments, the local codebase 270 may include a data folder 204 (e.g., a directory folder) containing files related to the generated functional test (e.g., test code, data, reports, etc.). A data directory structure 220 (e.g., a folder directory structure) of the local codebase 270 may indicate a choice of testing framework selected by the developer (e.g., a first type of BDD framework and/or a second type of BDD different from the first type of BDD). In some embodiments, the functional test assistance module 116 packages functional test framework scaffoldings with out-of-the-box integrations within the infrastructure of a respective environment (e.g., a reporting platform of a network environment).

The functional testing assistance module 116 may provide a plugin interface/IDE plugin 272 (e.g., provided by a CLI application and/or an IDE plugin) that receives requests (e.g., from components vertically below the plugin interface/IDE plugin 272, such as calls to an indexing service 206, an embedding service 208, a functional testing framework generation service 222, a functional testing generation component 232, a functional testing update service 248, a workflow coordination service 264) to perform various operations relating to functional tests (e.g., generating a new testing framework, generating new functional tests, updating existing functional tests, etc.). In some embodiments, the plugin interface (e.g., provided by the CLI application and/or the IDE plugin 272) allows for additional enhancements, such as support for new functional test frameworks and integration with updated or differently tuned generative models (e.g., hosted within the network environment, including open-source generative models, etc.), which may extend the functionality of the system (e.g., integrating different types of prompts for test or code generation use cases).

The plugin-based design may allow seamless integration of new features without affecting the underlying logic or architecture of the functional test assistance module 116. For example, the plugin architecture may utilize a facade design pattern that provides a simplified interface to a more complex subsystem. The functional testing assistance module 116 provides “developer proximity” by offering functionality within a native development environment-inside Integrated Development Environments (IDEs), as well as through a Command-Line Interface (CLI). The functional testing assistance module 116 may adopt a client-server architecture to provide responsive and centralized service delivery. In some embodiments, the CLI application and/or an IDE plugin 272 serves as the client-facing side of the functional testing assistance module 116, providing a conduit through which developers can access features of the functional testing assistance module 116 without leaving the development environment, resulting in functional testing capabilities that may be seamlessly integrated into the developer's workflow. For example, functionalities of the functional test assistance system may be provided as a Command-Line-Application executable (optionally downloadable by developers to start using on their local computing system) and/or on their IDE integrated terminal. In some embodiments, the functional testing assistance module 116 is packaged with interactive prompts and developers can run the command line application directly from their IDE and interact with the functional testing assistance module 116 via the interactive prompts.

The server component of functional testing assistance module 116 (e.g., Identity and Access Management (IAM) 282, management tool 284, LLMs 130, vector database 288, and embedding API 290) encapsulates the model-driven functionalities (e.g., provided by the LLMs 130, the vector database 288, and the embedding API 290), and may help maintain the processing workload independently from the client side, which operates within the local environment. In some embodiments, when the functional testing assistance module 116 is invoked, either through the plugin or the CLI, the functional testing assistance module 116 communicates with a central server to process requests. The central server may utilize a suite of models and tools to generate or update functional tests based on the provided API documentation and/or existing test suite context. In some embodiments, the outputs—functional tests and associated code—are written directly into the local codebase 270 by the plugin. In some embodiments, generated functional tests and associated code may be reviewed, refined, and/or revised before the outputs are provided to source control repositories.

The functional testing assistance module 116 may include a backend for frontend (BFF) component 274 that interfaces with various backend operations (e.g., from components vertically below the BFF component 274, such as a processor 210 that prepares files for embedding, a component 224 for fetching code for generating the testing framework scaffolding, etc.).

The functional testing assistance module 116 may include a large language model (LLM) gateway 276 that interfaces between calls made by internal modules of the functional testing assistance module 116 (e.g., from components vertically below the LLM gateway 276, such as by a prompt builder within the functional test generation module 226 that provides input to and receives output from large language models, etc.) and the LLMs 130 hosted on infrastructure within the platform.

The functional testing assistance module 116 may include a context retrieval component 278 that interfaces between calls made by internal modules of the functional testing assistance module 116 (e.g., from components vertically below the context retrieval component 278, such as by an identification module 256 that receives output from a vector database 288 identifying relevant portions of one or more existing functional test(s) that are impacted by an updated version of requirement information). The functional test assistance module 116 may support context retention of existing functional tests and automation code, enabling retrieval augmented generation (RAG) using LLMs to update only affected tests or code when requirements or API contracts change. In RAG, a reference knowledge base distinct from the training data is used to optimize the output of the LLM models so that, without retraining the LLM models, the LLM models can be extended to the network platform's internal knowledge base and/or other domains outside the training data. In some embodiments, the functional test assistance system uses RAG to index and embed test folder contents for context generation, and to determine which tests are affected in response to changes.

The functional testing assistance module 116 may include a data enrichment component 280 that interfaces between calls made by internal modules of the functional testing assistance module 116 (e.g., to generate embeddings from one or more functional tests) and an embedding API 290 hosted on infrastructure within the platform (e.g., calls from components vertically below the data enrichment component 280, such as by a database 240 that stores requirement information (e.g., derived from input 124-1) after the pre-processing component 126 has processed the input 124-1).

The functional testing assistance module 116 may include and/or interface with a deployment pipeline 298 (e.g., a cloud-platform deployment pipeline) that includes performing operations based on a configurational file 292 (e.g., a main configurational file, a configuration file that runs one of more functional tests provided by the functional test update component 242). In some embodiments, the functional test assistance module 116 also provides template configurations for running the functional tests on the entity's post-deployment pipeline 298 (e.g., an ecommerce environment's cloud-based platform's post-deployment pipeline). In some embodiments, the configuration file 292 is provided to a workflow server that orchestrates the operation of different systems on a platform (e.g., the ecommerce platform) through plugins created by users. The deployment pipeline 298 also includes a records maintenance module 294 (e.g., updating records associated with the functional tests, such as defect logs and the execution status of one or more functional tests) associated with the management tool 284, provided to the pipeline 298 by the workflow orchestration component 260. The deployment pipeline 298 also includes a reporting module 296 that reports and/or publishes results from the functional tests (e.g., via email, group messaging, etc.) to relevant parties (e.g., the developer, team members of a respective software development project). In some embodiments, the functional test assistance module described herein also includes workflow orchestration and/or smart defect analysis. For example, the functional test assistance module may use LLM 130 to perform contextual analysis of an error list generated from one or more functional tests (e.g., error stack traces) against existing or known errors/defects to minimize duplicating the same error in the error list.

Execution on the architecture of the functional testing assistance module 116 is described below in terms of the horizontal internal modules of the functional test generation module 226, the functional test update component 242, and the workflow orchestration component 260. In some embodiments, prior to responding to any user requests made to the functional testing assistance module 116, the functional testing assistance computing device 102 implements an authentication and authorization framework that aligns with enterprise security standards to ensure secure access to the functionalities of the functional testing assistance module 116, which is integrated deeply into the development workflow and may interact with sensitive codebases. For example, in some embodiments, an authentication and authorization layer 299 limits access to functionalities illustrated in FIG. 2 to the right of the layer 299.

In some embodiments, Lightweight Directory Access Protocol (LDAP) may be used for authentication to seamlessly verify the identity of users within the organization. The process may begin with Identity and Access Management (IAM) 282 redirection, where users are directed to a secure authentication service when they attempt to access the functionalities of the functional testing assistance module 116.

Once authenticated, authorization is managed through, for example, a cloud-based identity service that provides a broad range of identity and access capabilities. The identity service may maintain user-level permissions, controlling access to specific LLMs based on the user's role and permissions, which may help ensure that only authorized personnel can utilize certain functionalities of the functional testing assistance module 116. In some embodiments, usage metrics are captured and associated with user identities in the identity service. This may facilitate accurate tracking and calculation of costs related to the usage of different LLMs, ensuring transparent billing and resource management.

In some embodiments, upon a user's successful authentication and authorization, the functional testing assistance module 116 issues a unique application key to the user's local system. The unique application key is automatically appended to the header signature of every API call made to a system server from the client-side plugin of the functional testing assistance module 116. Such an approach may help to ensure that all interactions with the system server are secure and that each request can be traced back to a verified user session. In some embodiments, the application key is securely stored on the user's system, obviating the need for a user to repeatedly enter their credentials.

The functional test framework generation component 216 provides the initial setup and configuration of the functional test environments provided by the functional test assistance system. In some embodiments, the functional test framework generation component 216 automates the process of one or more of: researching available testing frameworks and tools, determining the best fit, and/or integrating the chosen framework with internal tools such as reporting systems and/or CI/CD pipeline configurations. Such an automated feature may help remove the complexity and effort typically associated with setting up a new testing environment from scratch. For example, the disclosed system may streamline the initiation process by providing a one-click functional test framework generation option for popular programming languages. In some embodiments, the provided test framework scaffolding may be pre-integrated with internal infrastructure of the ecommerce platform (e.g., internal reporting platform and/or preconfigured template files (e.g., YAML files)) that may facilitate a smoother transition to running functional tests on one or more new or existing pipelines of the ecommerce platform, and may reduce setup time and technical overhead for developers.

In some embodiments, functional test framework generation component 216 does not utilize generative AI, but uses a selection of vetted and curated functional test frameworks that are stored in an internal database or repository of the ecommerce platform. For example, when a developer selects a test framework, the functional test assistance system automatically clones the necessary files into the developer's local codebase 270, creating a new directory for the functional tests. This local instantiation enables immediate use and further customization of the functional tests, as needed, without interrupting the workflow of the developer with onerous setup procedures. In some embodiments, a functional test framework generated by the functional testing assistance module 116 (e.g., optionally in the developer's local codebase 270) may include a directory folder that consolidates configurational files, a directory folder that consolidates data relevant to simplified workflow rules configurations, one or more configurational files customized for a reporting system on a respective platform, one or more documentation files.

The functional test generation module 226 creates and maintains functional tests for software applications (e.g., after the testing framework has been created). Functional testing, often categorized under “black box testing,” may require a comprehensive understanding of an application's functionality from an external perspective, without insight into the internal code structure. Effective functional testing may involve interpreting software requirements to design tests that cover a broad spectrum of scenarios, including various edge cases and data combinations. The breadth of test coverage may be subjected to a developer's domain expertise and experience, leading to variability in the quality and comprehensiveness of the functional test cases created. The design and automation of functional tests may be among the most time-consuming aspects of the software development lifecycle. For example, each functional test may have to be meticulously designed with detailed steps, the corresponding code may have to be written to automate the designed steps, and appropriate test data may have to be identified and generated. Updates to API contracts or application functionalities may necessitate corresponding updates to existing function tests-a process that can be both time-consuming and error-prone.

The functional test generation module 226 incorporates generative AI to address the challenges described above. Utilizing Large Language Models (LLMs) with extensive technical and domain knowledge, the functional test generation module 226 may execute one or more models, processes, or algorithms, such as a machine learning model, deep learning model, statistical model, etc., (e.g., implemented as machine-readable instructions) to analyze functional requirements and generate structured tests, such as those in Behavior-Driven Development (BDD) format. The functional test generation module 226 may also automatically generate the corresponding test code (e.g., associated with one or more functional tests) for a wide array of programming languages and testing frameworks.

The functional test generation module 226 may execute one or more models, processes, or algorithms, such as a machine learning model (e.g., as implemented as machine-readable instructions) to analyze functional requirements prior to producing a comprehensive suite of tests to ascertain if a software application meets the functional requirements. By analyzing the requirements, the functional test generation module 226 intelligently generates critical (e.g., P1) and secondary (e.g., P2 and/or P3) tests, ensuring a depth of coverage that may otherwise be unattainable for developers with limited domain knowledge.

In some embodiments, the functional test generation module 226 receives input 218, such as a first version of requirement information for a software application. The input 218 may include API requirement documentation, which may be in the form of specifications in JSON format (e.g., Swagger specifications) or introspection queries (e.g., Swagger queries). The input 218 may include documents that provide comprehensive outlines of the API's intended behavior (e.g., detailing endpoints, expected requests, and/or responses).

The functional test generation module 226 includes a pre-processing component 126 that intelligently segments the first version of the requirement information (e.g., provided API specifications in the input 218) into respective portions, such as tokens that are suitable for use with LLMs. The pre-processing component 126 breaks down the specification in the input 218 into the respective portions that include logical chunks, focusing on individual endpoints and their associated data. These logical chunks may include mandatory headers, parameters, request body schemas, and different response bodies, tailored to give the LLMs sufficient contextual understanding necessary for generating accurate functional tests.

The functional test generation module 226 includes an LLM prompting module 128 that includes a prompt builder containing or having access to (e.g., communicatively connected to a database) engineered prompts designed to work with LLMs. In some embodiments, the engineered prompts (e.g., stored engineered prompts or engineered prompts generated in real-time) are inputs, generated based on the respective portions (e.g., the segmented respective portions), to the LLMs 130 to help guide the LLMs 130 to produce precise, high-quality functional tests for one or more frameworks (e.g., frameworks such as Cucumber BDD or Karate BDD).

In some embodiments, the prompt builder in the LLM prompting module 128 uses few-shot prompting techniques and/or sets the temperature parameter to a suitable value (e.g., zero or a low value) to direct the LLMs 130 to replicate the standards and best practices exemplified in examples provided to the LLMs 130. Temperature parameter configurations may be used for fine-tuning the temperature parameter to ensure similar output for similar requirement specifications. For example, a platform specific sample test, code snippets, and/or API documentation may be provided via few-shot prompting to help ensure consistent syntax and/or output from the LLMs 130, and/or to achieve optimal functional test coverage. In some embodiments, the prompt builder in the LLM prompting module 128 generates parameterized test steps, which may enhance test coverage by facilitating the execution of variations of a test when different datasets are used. In some embodiments, the prompt builder may utilize prompt chaining to generate subsequent test cases by reusing behavior-driven development (BDD) steps from initial tests, to optimize the generated tests while maintaining consistency. Table 1 below shows a sample prompt, generated by the prompt builder in the LLM prompting module 128:

TABLE 1
sample prompt generated by the prompt builder in the LLM prompting module 128.

```
Sample prompt for generating tests in an example BDD format (e.g., Karate BDD) using an API
specification (e.g., Swagger API specification)-
prompt = Your task is to understand the functionality of every API endpoint and its parameters
provided in the user's json file and do the following:\
  \n 1. Create comprehensive API functional tests in example BDD format for endpoint under
\″paths\″ \
  \n 2. Ensure all headers are declared on the first line of every scenario using the correct syntax
in this way only example - “‘Authorization : ′<authorization>′“‘\
  \n 3. Ensure to never use # for parameterization, use only < > instead Example “‘<token>“‘\
  \n 4. Identify schema contains enum then add all values in Examples only.\
  \n 5. Ensure for all status codes provided in the user's json file like 200, 400 are added as
dataset under Examples for every Scenario Outline responses.\
  \n 6. For success test case, ensure to add an assertion for the functionality by mentioning the
json path from response schema in the Examples.\
  \n 7. Ensure to understand the functionality of the endpoints and create an assertion for the
same from the response schema with correct json path.\
  \n User provide json file - “‘ { json file} “‘
role = For this json “‘{sample_json} “‘ this is the generated example BDD feature “‘ {feature}
“‘.\
  \n Generate for other json file in this way only.
gptmodel = gpt-4-32k
temperature =0.1
responseTokens =3500
```

The output from the LLMs 130 passes through a post-processor 236, which refines output of generated content from the LLMs 130. For example, the post-processor 236 receives and processes one or more outputs from the trained LLMs 130 to generate one or more functional tests that determine whether the software application satisfies the first version of the requirement information specified in the respective portions. In some embodiments, the post-processor 236 may sanitize the output from the LLMs 130 by stripping away any superfluous information that may have been included in the output and/or verifies that the output adheres to the expected format. In accordance with a determination that the output from the LLMs 130 does not meet the functional testing assistance module 116's standards, the post-processor 236 may initiate a re-run of the prompt builder in the LLM prompting module 128. In accordance with a determination that the output from the LLMs 130 meets the functional testing assistance module 116's standards, the post-processor 236 may write the post-processed output of the LLM 130 to a file (e.g., a “feature” file) and provide the file to the functional test generation component 232. In some embodiments, the post-processor 236 also integrates the functional tests generated by the functional test generation component 232 into a data folder 230 in the developer's local codebase 270 (e.g., by managing a “functional-test” directory), and may handle any potential file duplication or conflicts within the data folder 230. Table 2 below shows an example functional test generated by the functional test generation component 232.

TABLE 2
An example functional test in an example BDD format
generated for an example specification.

PromotionManagement.feature
Scenario Outline: Verify GET Promotional Prices API
Given I have the API <end_point>
And I have the following request headers:
| xyz.ACCESS_TOKEN | <access_token>|
| Authorization| <authorization>
| xyy._CORRELATION_ID | <correlation_id>|
| xzz.CHANNEL.TYPE | <channelType>
|yyy.NAME |<svc_name> }
When I make a “GET” request on <path> with the path parameters:
|sku |<sku> }
Then the API should return a response with status code <status_code?
And Validate the expected <message> displayed on the json path <json_path>
Examples:
|end_point| path| authorization| channelType|access_token| correlation_id| svc_name|
status_code |sku| json_path| message|
| “http://testingsite.http”| “/v1/promo/sku/{sku}”| “abcdef”| “xyz”| “abcdef”| “test”|
“PromotionManagement” | 200|

In some embodiments, when existing API contracts or functionalities undergo changes, the functional testing assistance module 116 uses its AI-driven capabilities differently. By understanding the context of the changes, a functional test update component 242 in the functional testing assistance module 116 may update the relevant tests (e.g., only the relevant tests) by making precise modifications to existing functional tests to maintain the accuracy and relevance of the existing functional tests in the test suite.

In some embodiments, the update process commences when the functional test update component 242 receives input 124-2 containing updated API requirement documentation. In some embodiments, the functional testing assistance module 116 may automatically search, monitor updates and/or locate the updated input 124-2 in requirement information for respective software applications without direct and/or active input from the user. The input 124-2 may be, for example, an updated contract such as a Swagger specification or a GraphQL introspection query. The input 124-2 triggers the functional test assistance module 116 to initiate a sequence of operations to update the functional tests.

To maintain a current and searchable index of existing functional tests, the functional test assistance module 116 includes a codebase change detection and embedding module 202, which performs data enrichment tasks, optionally on a regular (e.g., scheduled) basis. The codebase change detection and embedding module 202, by invoking an embedding service 208 provided by the IDE plugin 272, processes files (e.g., files relating to the functional tests) using the processor 210, which provides processed input to a component 274, which generates embeddings for each component of the test suite using an embedding model accessible through an API 290 (e.g., embedding model “text-embedding-ada-002”) hosted on the entity's server or platform. For example, the codebase change detection and embedding module 202 generates embeddings associated with the one or more functional tests. These embeddings may represent the semantic essence of the functional tests and are stored in a vector database 288 to allow for efficient retrieval.

Upon receiving the input 124-2 that includes updates to the API requirement documentation (e.g., original input 124-1) such as, for example, an updated version of the requirement information for the software application and/or an updated API contract, the functional test assistance module 116 invokes a context retrieval component 278. For example, in some embodiments, in response to receiving an updated version of the requirement information for the software application, the context retrieval component 278 identifies one or more semantic differences between the updated version of the requirement information and the first version of the requirement information. Utilizing semantic search and the power of the embeddings stored in the vector database 288, the context retrieval component 278 locates the relevant portions of the existing suite of functional tests that correspond to the updated version of the requirement information, and returns the relevant portions as data (e.g., formatted as files) to identification module 256 of the functional test update component 242. The data received by the identification module 256 (e.g., from the context retrieval component 278) is provided to an orchestrator 250, which also receives the input 124-2. In some embodiments, the database 240 also provides information from API specifications (e.g., derived from the input 124-1), optionally with information about the version of the API specifications, to the semantic comparison module 134, which in turn fetches the changes in the API specification that are provided to the identification module 256. In some embodiments, this focused retrieval ensures that only the necessary tests are flagged for updating, and may help to preserve the integrity of the rest of the test suite.

The orchestrator 250 includes a pre-processor analogous to the pre-processing component 126 in the functional test generation module 226 (e.g., used for first-time test generation) to handle the updates contained in the input 124-2. The pre-processor in the orchestrator 250 parses the updated API documentation in the input 124-2, dissecting the updated input 124-2 into logical chunks that are suitable for generating structured prompts that are ready for the LLMs 130 to process. In some embodiments, the pre-processor may ensure that the context from the input 124-2 is clear and actionable. The pre-processed portions of the relevant parts of the new API documentation in the input 124-2 are provided to a prompt builder in an LLM prompting module 254, which is analogous to the LLM prompting module 128, to generate a modified input (e.g., a modified input prompt to the LLMs 130) to the trained LLMs 130, based on the semantic differences and the embeddings associated with the one or more functional tests. In some embodiments, the prompt builder in the LLM prompting module 254 crafts prompts that integrate the retrieved context (e.g., from the context retrieval component 278) with the changes identified by the pre-processor in the orchestrator 250. In some embodiments, the engineered prompts may guide the LLMs 130 to refactor only the portions of the test suite (e.g., enhancing the code of the test suits while maintaining the external behavior of the test suite without changing its external behavior) that are affected by the changes specified in the input 124-2 such that only those parts of the functional tests that are impacted by the API update specified in the input 124-2 are updated.

A post-processor 252, analogous to post-processor 236 in the functional test generation module 226, receives and processes one or more modified outputs (e.g., based on the modified input generated from the semantic differences and the embeddings associated with the one or more functional tests) from the LLMs 130 (e.g., received via the LLM prompting module 254), including checking that the modified output from the LLMs 130 is correctly formatted, in order to generate one or more updated functional tests that determine whether the software application satisfies the updated version of the requirement information, and integrating the updated functional tests into a local file structure 246 in the developer's codebase 270. The post-processor 252 updates the affected functional testing files (e.g., stored in the data folder 230, or another file directory associated with the functional tests), replacing old functional tests with new functional tests, or revising the old functional tests as needed. In some embodiments, the post-processor 252 also manages any potential conflicts within the data consolidated in the local file structure 246, and may ensure that the updates to the functional tests are coherent and complete.

Conventional functional testing management/coordination tools for test artifact management and defect logging may be manual, time-consuming, and prone to human error. Further, conventional testing management/coordination tools may not automatically upload newly designed functional tests, manage test data for execution in different environments, generate test execution sets, update test statuses, and manage defect associations. Manual logging of defects from test automation results in conventional tools may lead to redundancy and lack of sufficient oversight of the functional test data logging process. For example, duplicate defect tickets may be created for the same issue or error identified via functional testing. In contrast, functional test assistance module 116, by virtue of processing updated inputs, may be able to ensure that updated requirements are taken into account in the software development process. The functional test assistance module 116 may allow unique defects to be automatically identified (e.g., by consolidating duplicated tickets), reducing the number of defect tickets a developer may have to address.

In some embodiments, a workflow orchestration component 260 may automate and streamline interactions with a management tool 284 used in the software development lifecycle for managing test artifacts and defects. In some embodiments, the workflow orchestration component 260 may require only a configuration file specifying configuration properties and various details of the workflow management tool 284 to provide automation capabilities. The workflow orchestration component 260 may also have access to a data folder 262 (e.g., within a local codebase 270) to store data files associated with execution of functional tests. The functional test assistance module 116 simplifies the upload process by using a coordination component 266 within the workflow orchestration component 260 to add the generated functional tests (e.g., from a file directory or folder associated with the functional tests) to the management tool 284. For example, the management tool 284 may be a platform specific management tool (e.g., an internal management tool of an ecommerce platform). In some embodiments, the coordination component 266 also downloads functional tests stored on the management tool 284, optionally based on various criteria provided in a configuration file.

In some embodiments, the workflow orchestration component 260 reintegrates test data into the feature files (e.g., BDD feature files) and prepares them for execution (e.g., executing the functional tests). In some embodiments, the coordination component 266 also keeps a defects log detailing aspects of the software application that does not meet the first version or updated version of the requirement information for the software application. In some embodiments, the workflow orchestration component 260 also tracks newly created test IDs associated with the uploaded functional tests. In some embodiments, the test IDs may be stored in a database (e.g., as a “config.properties” file) for future reference. In some embodiments, the workflow orchestration component 260 parses and processes test data within one or more feature files (e.g., a BDD feature file), and generates a dedicated “testdata.json” file for each environment, which may facilitate easy access to environment-specific test data during test execution. In some embodiments, the coordination component 266 uses the test results or reports generated post-execution, and updates test execution status stored in the management tool 284 to help ensure that the results from the functional tests are accurately reflected in the project tracking.

In some embodiments, the workflow orchestration component 260 also includes a defect analysis component 268 that receives results and reports (e.g., a defect stack trace) after the functional tests have been executed, and parses the failure logs from the test reports to identify unique issues. In some embodiments, the defect analysis component 268 uses the LLMs 130 to compare failure contexts in the failure logs against existing defects (e.g., by performing contextual analysis of error stack traces against existing open defects in the management tool 284) to determine if a new defect should be logged or if an existing ticket should be linked to results from the run of the functional test (e.g., using LLMs to identify and/or minimize duplicate defects). For example, the LLMs 130 may find similarities between defects identified in the reports, defect logs, and/or defect stack trace with existing defects already logged in the management tool 284. For example, duplicate defects (e.g., one or more defects in the report or defect stack trace that are substantially similar or identical to existing defects already logged) may be removed, or tabulated with a counter indicating the number of occurrences of a particular defect. In some embodiments, an existing defect stored in a log or database in the management tool 284 is checked to see if that defect has been addressed (e.g., by an updated iteration of the software application) or if the defect has yet to be addressed (e.g., it is an “open” defect).

In some embodiments, the workflow orchestration component 260 automates previously manual processes, which may not only reduce administrative burden on developers but may also minimize the risk of errors in test management and defect logging. The workflow orchestration component 260 may ensure that software benchmarking milestones (e.g., formulated based on the requirement information for the software application), as recorded and stored in the management tool 284 remain current and accurate.

Functional testing assistance module 116 is based on a modular and extensible architecture that may facilitate its ease of use and integration. For example, the functionalities of the functional testing assistance module 116 may be extended by adding more functional modules that are responsive to dynamic needs of software testing. In some embodiments, the functional testing assistance module 116 may help foster a collaborative environment conducive to internal sourcing within a particular platform (e.g., an ecommerce platform). For example, developers using the same functional testing assistance module 116 (e.g., across the organization) may contribute to upgrades of the functional testing assistance module 116, which may help foster a sense of ownership and engagement among the development community.

The modularity of the functional testing assistance module 116 includes the functional test framework generation component 216, which may be expanded to support the addition of new test frameworks as scaffolding options in various programming languages. The functional test generation module 226 may accommodate support for additional Large Language Models (LLMs) and/or various functional test syntaxes. The workflow orchestration component 260 may facilitate the integration of new or enhanced capabilities for managing tests and defects within the management tool 284, for example, due to changes in project management workflows and tools.

The functional testing assistance module 116 uses a plugin architecture that abstracts away from inner components (e.g., core components), such as the prompt builder in the LLM prompting module 128, the prompt builder in the LLM prompting module 254, the pre-processor that segments the input 124-1 and/or input 124-2. The use of a plugin architecture may ensure that the addition or modification of modules does not result in alterations to the base code or underlying logic. In some embodiments, the abstraction layer provided by the plugin architecture may promote a clean separation of concerns, and may enable developers to contribute new plugins or enhance existing ones without the risk of inadvertently affecting the functional testing assistance module 116's foundational operations. In some embodiments, the workflow orchestration component 260 may help process inputs and orchestrate the execution of tasks across various plugins.

In some embodiments, the functional testing assistance module 116 can be expanded to and modified to provide user interface (UI) testing (e.g., to determine if various elements displayed or provided in a user interface is correctly linked to the respective target, and if the UI elements behave according to specifications). For example, a UI testing assistance module may support front-end browser test automation for UI applications using various available UI functional test frameworks. By leveraging generative AI, the UI testing assistance module may record user interactions on web applications and generate functional BDD tests and automation code compatible with these frameworks. In some embodiments, computer vision algorithms may be integrated with the UI testing assistance module to perform visual UI testing by accurately identifying UI elements to detect visual anomalies, and ensure consistent UI behavior across different devices and screen sizes.

In some embodiments, the functional testing assistance module 116 can be expanded to and modified to provide End-to-End (E2E) testing. E2E testing or integration testing may utilize internally hosted LLMs trained on domain and technical knowledge of different applications integrated into a specific platform (e.g., the ecommerce ecosystem). Such LLMs may generate E2E tests based on requirements or contracts in order to validate the complete functionality of integrated systems. In some embodiments, the testing assistance module may automatically detect changes in integrated application environments and dynamically adjust generated E2E tests accordingly.

In some embodiments, the functional testing assistance module 116 can be expanded to and/or modified to provide mobile application testing. In some embodiments, mobile application testing may involve automation provided by a recording plugin, that is optionally built atop a mobile application client and used to capture user interactions on mobile applications, which generates functional BDD tests and custom automation code. In some embodiments, generative AI LLM models may enhance test coverage by interpreting requirement documentation accurately.

In some embodiments, a 50% reduction in manual bandwidth during functional testing may be achieved, encompassing tasks such as requirement analysis, functional test design, test automation, and debugging. In some embodiments, a 100% P1 functional test coverage for services and increases in P2 and P3 functional test coverage (e.g., addressing areas that were previously overlooked during manual test designs) may be achieved.

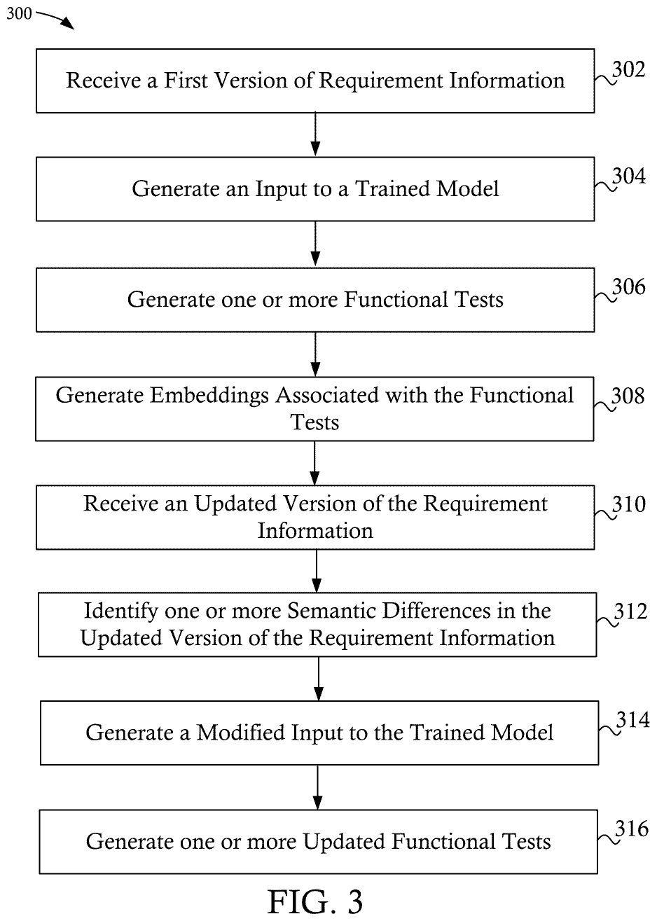

FIG. 3 is a flow diagrams depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 3 may be implemented in the form of executable instructions stored on a machine readable media and executed by a processing resource and/or in the form of electronic circuitry. For example, aspects of the method may be described below as being performed by a functional testing assistance system, an example of which may be the functional testing assistance system 116 running on a hardware processing resource 104 of the functional testing assistance computing device 102 described above. Additionally, other aspects of the method described below may be described with reference to other elements shown in FIG. 1 for non-limiting illustration purposes.

FIG. 3 is a flowchart illustrating a functional testing generation and updating method in accordance with some embodiments. A functional testing generation and updating method 300 begins at step 302 with receiving a first version of requirement information, such as receiving a first version of requirement information for a software application. The method 300 includes segmenting the first version of the requirement information into respective portions. At step 304, the method 300 includes generating an input to a train model (e.g., a large language model). For example, the method 300 includes generating an input to a trained model based on the respective portions. At step 306, the method 300 includes generating one or more functional tests. For example, the method 300 includes receiving and processing one or more outputs from the trained model to generate one or more functional tests that determine whether the software application satisfies the first version of the requirement information specified in the respective portions. At step 308, the method 300 includes generating embeddings associated with the functional tests. At step 310, the method 300 includes receiving an updated version of the requirement information. At step 312, the method 300 includes identifying one or more semantic differences in the updated version of the requirement information. For example, the method 300 includes, in response to receiving an updated version of the requirement information for the software application: identifying one or more semantic differences between the updated version of the requirement information and the first version of the requirement information. At step 314, the method 300 includes generating a modified input to the trained model. For example, the method 300 includes generating a modified input to the trained model based on the semantic differences and the embeddings associated with the one or more functional tests. At step 316, the method 300 includes generating one or more updated functional tests. For example, the method 300 includes receiving and processing one or more modified outputs from the trained model to generate one or more updated functional tests that determine whether the software application satisfies the updated version of the requirement information.

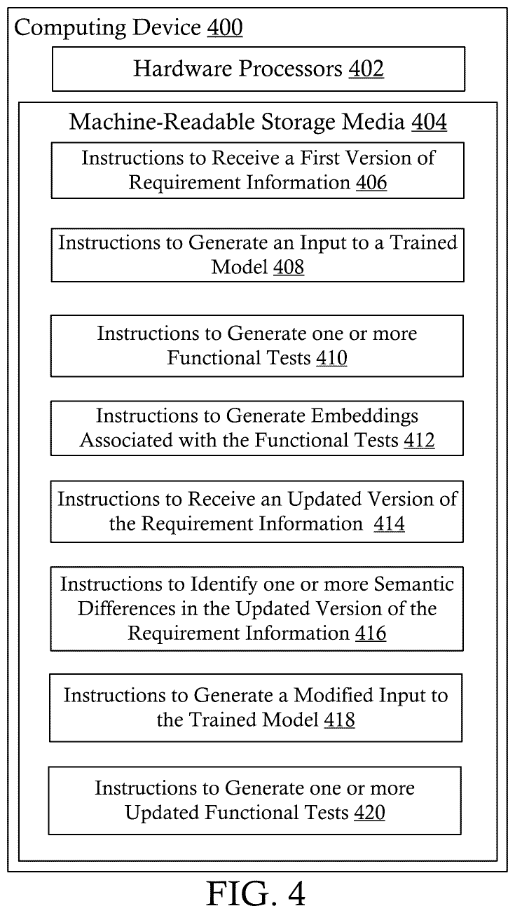

FIG. 4 depicts an example system 400 that includes non-transitory, machine readable media 404 encoded with example instructions executable by processing resource 402. In some implementations, the system 400 may be useful for implementing aspects of the functional testing assistance system 116 of FIG. 1 or for performing aspects of method 300 of FIG. 3. For example, the instructions encoded on machine readable media 404 may be included in instructions 108 of FIG. 1. In some implementations, functionality described with respect to FIG. 1 may be included in the instructions encoded on machine readable media 404.

The processing resources 402 may include a microcontroller, a microprocessor, central processing unit core(s), an ASIC, an FPGA, and/or other hardware device suitable for retrieval and/or execution of instructions from the machine readable media 404 to perform functions related to various examples. Additionally or alternatively, the processing resources 402 may include or be coupled to electronic circuitry or dedicated logic for performing some or all of the functionality of the instructions described herein.

The machine readable media 404 may be any medium suitable for storing executable instructions, such as RAM, ROM, EEPROM, flash memory, a hard disk drive, an optical disc, or the like. In some example implementations, the machine readable media 404 may be a tangible, non-transitory medium. The machine readable media 404 may be disposed within the system 400, in which case the executable instructions may be deemed installed or embedded on the system. Alternatively, the machine readable media 404 may be a portable (e.g., external) storage medium, and may be part of an installation package.

As described further herein below, the machine readable media 404 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 4.

With reference to FIG. 4, the machine readable media 404 includes instructions 406-420. Instructions 406, when executed cause the processing resource 402 to receive a first version of requirement information. Instructions 408, when executed, cause the processing resource to generate an input to a trained model. Instructions 410, when executed, cause the processing resource to generate one or more functional tests. Instructions 412, when executed, cause the processing resource to generate embeddings associated with the functional tests. Instructions 414, when executed, cause the processing resource to receive an updated version of the requirement information. Instructions 416, when executed, cause the processing resource to identify one or more semantic differences in the updated version of the requirement information. Instructions 418, when executed, cause the processing resource to generate a modified input to the trained model. Instructions 420, when executed, cause the processing resource to generate one or more updated functional tests. For example, the instructions, when executed by the at least one processor (e.g., the one or more processing resources 402), cause the at least one device (e.g., the system 400) to perform operations including: receiving a first version of requirement information for a software application; generating an input to a trained model based on the respective portions; receiving and processing one or more outputs from the trained model to generate one or more functional tests that determine whether the software application satisfies the first version of the requirement information specified in the respective portions; generating embeddings associated with the functional tests; in response to receiving an updated version of the requirement information for the software application: identifying one or more semantic differences between the updated version of the requirement information and the first version of the requirement information; generating a modified input to the trained model based on the semantic differences and the embeddings associated with the one or more functional tests; generating one or more updated functional tests; and receiving and processing one or more modified outputs from the trained model to generate one or more updated functional tests that determine whether the software application satisfies the updated version of the requirement information.

Training models based on training data so that the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

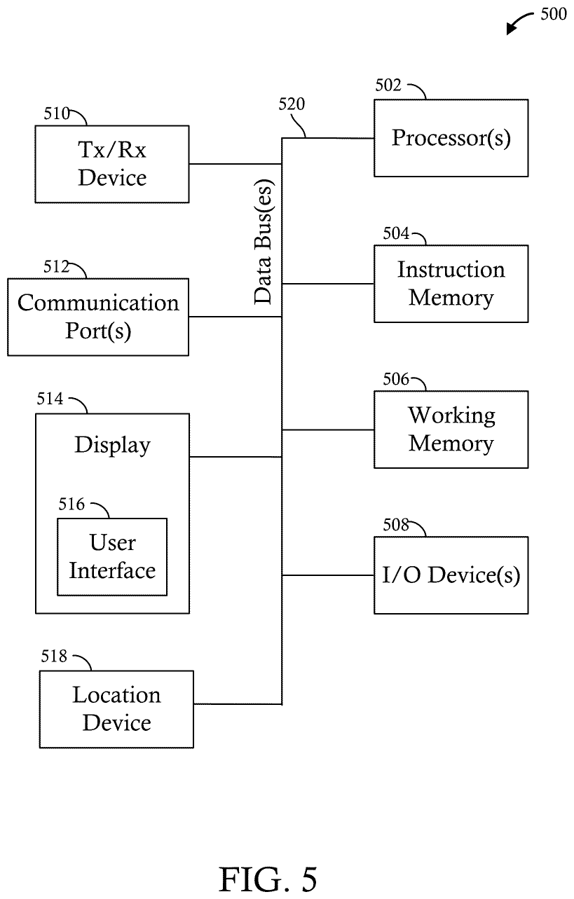

FIG. 5 is a block diagram of an example functional testing assistance computing device in accordance with some embodiments. Although FIG. 5 is described with respect to certain components shown therein, it will be appreciated that the elements of a computing device 500 (e.g., corresponding to the functional testing assistance computing device 102) may be combined, omitted, and/or replicated. In addition, it will be appreciated that additional elements other than those illustrated in FIG. 5 may be added to the computing device.

As shown in FIG. 5, the computing device 500 may include one or more processing resources 502, instruction memory 504, working memory 506, input/output devices 508, transceiver 510, communication ports 512, display 514, optional location device 518, and/or any other suitable elements each operatively coupled to one or more data buses 520. The data buses 520 allow for communication among the various components. The data buses 520 may include wired, or wireless, communication channels.

The one or more processing resources 502 may include any processing circuitry operable to control operations of the computing device 500. In some embodiments, the one or more processing resources 502 include one or more distinct processors, each having one or more cores (e.g., processing circuits). Each of the distinct processors may have the same or different structure. The one or more processing resources 502 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 502 may also be implemented by a controller, a microcontroller, an application specific integrated circuit (ASIC), a field programmable gate array (FPGA), a programmable logic device (PLD), etc.

In some embodiments, the one or more processing resources 502 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 504 may store instructions that are accessed (e.g., read) and executed by at least one of the one or more processing resources 502. For example, the instruction memory 504 may be a non-transitory, computer-readable storage medium such as a read-only memory (ROM), an electrically erasable programmable read-only memory (EEPROM), flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 502 may perform a certain function or operation by executing code, stored on the instruction memory 504, embodying the function or operation. For example, the one or more processing resources 502 may execute code stored in the instruction memory 504 to perform one or more of any function, method, or operation disclosed herein.

Additionally, the one or more processing resources 502 may store data to, and read data from, the working memory 506. For example, the one or more processing resources 502 may store a working set of instructions to the working memory 506, such as instructions loaded from the instruction memory 504. The one or more processing resources 502 may also use the working memory 506 to store dynamic data created during one or more operations. The working memory 506 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 504 and working memory 506, it will be appreciated that the computing device 500 may include a single memory unit that operates as both instruction memory and working memory. Further, although embodiments are discussed herein including non-volatile memory, it will be appreciated that computing device 500 may include volatile memory components in addition to at least one non-volatile memory component.

In some embodiments, the instruction memory 504 and/or the working memory 506 includes an instruction set, in the form of a file for executing various methods, such as methods for generating and providing functional tests, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 502.

The input-output devices 508 may include any suitable device that allows for data input or output. For example, the input-output devices 508 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 510 and/or the communication port(s) 512 allow for communication with a network, such as the communication network 114 of FIG. 1A. For example, if the communication network 114 of FIG. 1A is a cellular network, the transceiver 510 allows communications with the cellular network. In some embodiments, the transceiver 510 is selected based on the type of the communication network 114 the computing device 500 will be operating in. The one or more processing resources 502 are operable to receive data from, or send data to, a network, such as the communication network 114 of FIG. 1A, via the transceiver 510.

The communication port(s) 512 may include any suitable hardware, software, and/or combination of hardware and software that is capable of coupling the computing device 500 to one or more networks and/or additional devices. The communication port(s) 512 may be arranged to operate with any suitable technique for controlling information signals using a desired set of communications protocols, services, or operating procedures. The communication port(s) 512 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 512 allows for the programming of executable instructions in the instruction memory 504. In some embodiments, the communication port(s) 512 allow for the transfer (e.g., uploading or downloading) of data, such as machine learning model training data.

In some embodiments, the communication port(s) 512 couples the computing device 500 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 510 and/or the communication port(s) 512 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 514 may be any suitable display, and may display the user interface 516. The user interfaces 516 may enable user interaction with the functional testing assistance module 116 (e.g., via the IDE plugin 272). For example, the user interface 516 may be a user interface of the IDE plugin 272, which includes interactive features for a user to send a request to the functional testing assistance module 116 to generate new functional tests for an application and/or update one or more existing functional tests based on an updated version of the requirement information for the software application. In some embodiments, a user may interact with the user interface 516 by engaging the input-output devices 508. In some embodiments, the display 514 may be a touchscreen, where the user interface 516 is displayed on the touchscreen.

The display 514 may include a screen such as, for example, a Liquid Crystal Display (LCD) screen, a light-emitting diode (LED) screen, an organic LED (OLED) screen, a movable display, a projection, etc. In some embodiments, the display 514 may include a coder/decoder, also known as Codecs, to convert digital media data into analog signals. For example, the visual peripheral output device may include video Codecs, audio Codecs, or any other suitable type of Codec.

The optional location device 518 may be communicatively coupled to a location network and operable to receive position data from the location network. For example, in some embodiments, the location device 518 includes a GPS device that receives position data identifying a latitude and longitude from one or more satellites of a GPS constellation. As another example, in some embodiments, the location device 518 is a cellular device that receives location data from one or more localized cellular towers. Based on the position data, the computing device 500 may determine a local geographical area (e.g., town, city, state, etc.) of its position.

In some embodiments, the computing device 500 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 500 may be a computer, a workstation, a laptop, a server such as a cloud-based server, or any other suitable device. In some embodiments, the computing device 500 is a server that includes one or more processing units, such as one or more graphical processing units (GPUs), one or more central processing units (CPUs), and/or one or more processing cores. The computing device 500 may, in some embodiments, execute one or more virtual machines. In some embodiments, processing resources (e.g., capabilities) of the computing device 500 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

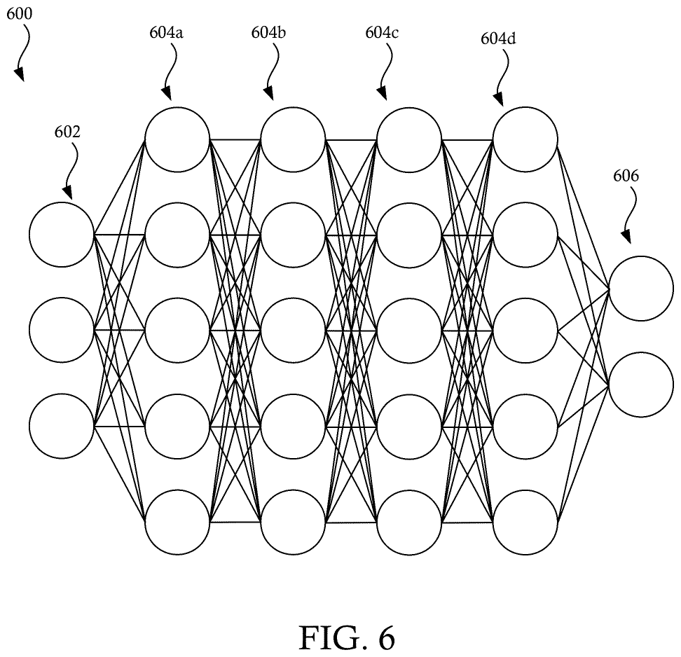

FIG. 6 illustrates a deep neural network (DNN) 600, in accordance with some embodiments. The DNN 600 is an artificial neural network that includes representation learning. The DNN 600 may include an unbounded number of (e.g., two or more) intermediate layers 604a-604d each of a bounded size (e.g., having a predetermined number of nodes), providing for practical application and optimized implementation of a universal classifier. Each of the layers 604a-604d may be heterogenous. The DNN 600 may model complex, non-linear relationships. Intermediate layers, such as intermediate layer 604c, may provide compositions of features from lower layers, such as layers 604a, and 604b, providing for modeling of complex data.

In some embodiments, the DNN 600 may be considered a stacked neural network including multiple layers that each execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 600 is a feedforward network in which data flows from an input layer 602 to an output layer 606 without looping back through any layers. In some embodiments, the DNN 600 may include a backpropagation network in which the output of at least one hidden layer is provided, e.g., propagated, to a prior hidden layer. The DNN 600 may include any suitable neural network, such as a self-organizing neural network, a recurrent neural network, a convolutional neural network, a modular neural network, and/or any other suitable neural network.

In some embodiments, a DNN 600 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 600 may include a neural multiplicative model (NMM), including a multiplicative form for the NAM mode using a log transformation of the dependent variable y and the independent variable x:

$$y = {e}^{β} {e}^{f ( logx )} {e}^{{\sum }_{i} {f}_{i}^{d} ( {d}_{i} )}$$

where d represents one or more features of the independent variable x.

Although the subject matter has been described in terms of example embodiments, it is not limited thereto. Rather, the appended claims should be construed broadly, to include other variants and embodiments, which may be made by those skilled in the art.

What is claimed is:

1. A system, comprising:
a processor; and
a non-transitory memory storing instructions, that when executed, cause the processor to:
receive a first version of requirement information for a software application;
segment the first version of the requirement information into respective portions;
generate an input to a trained model based on the respective portions;
receive and process one or more outputs from the trained model to generate one or more functional tests that determine whether the software application satisfies the first version of the requirement information specified in the respective portions;
generate embeddings associated with the one or more functional tests; and
in response to receiving an updated version of the requirement information for the software application:
identify one or more semantic differences between the updated version of the requirement information and the first version of the requirement information;
generate a modified input to the trained model based on the semantic differences and the embeddings associated with the one or more functional tests; and
receive and process one or more modified outputs from the trained model to generate one or more updated functional tests that determine whether the software application satisfies the updated version of the requirement information.

2. The system of claim 1, wherein the input to the trained model comprises a prompt that causes the trained model to provide the one or more outputs to generate the one or more functional tests.

3. The system of claim 1, wherein the instructions cause the processor to receive, after the one or more functional tests have been executed, at least one report identifying which portion of the updated version of the requirement information the software application fails to meet.

4. The system of claim 3, wherein the instructions cause the processor to parse the at least one report to identify non-duplicated defects from the at least one report.

5. The system of claim 1, wherein the embeddings associated with the one or more functional tests are stored in a vector database for retrieval.

6. The system of claim 5, wherein the instructions cause the processor to perform a semantic search on the embeddings stored in the vector database to locate relevant portions of the one or more functional tests that correspond to the updated version of the requirement information.

7. The system of claim 1, wherein the first version of the requirement information that is segmented into the respective portions comprises logical chunks having respective individual endpoints and associated data to provide contextual information to the trained model.

8. A computer-implemented method, comprising:
receiving a first version of requirement information for a software application;
segmenting the first version of the requirement information into respective portions;
generating an input to a trained model based on the respective portions;
receiving and processing one or more outputs from the trained model to generate one or more functional tests that determine whether the software application satisfies the first version of the requirement information specified in the respective portions;
generating embeddings associated with the one or more functional tests; and
in response to receiving an updated version of the requirement information for the software application:
identifying one or more semantic differences between the updated version of the requirement information and the first version of the requirement information;
generating a modified input to the trained model based on the semantic differences and the embeddings associated with the one or more functional tests; and
receiving and processing one or more modified outputs from the trained model to generate one or more updated functional tests that determine whether the software application satisfies the updated version of the requirement information.

9. The computer-implemented method of claim 8, wherein the input to the trained model comprises a prompt that causes the trained model to provide the one or more outputs to generate the one or more functional tests.

10. The computer-implemented method of claim 8, further comprising receiving, after the one or more functional tests have been executed, at least one report identifying which portion of the updated version of the requirement information the software application fails to meet.

11. The computer-implemented method of claim 10, further comprising parsing the at least one report to identify non-duplicated defects from the at least one report.

12. The computer-implemented method of claim 8, wherein the embeddings associated with the one or more functional tests are stored in a vector database for retrieval.

13. The computer-implemented method of claim 12, further comprising performing a semantic search on the embeddings stored in the vector database to locate relevant portions of the one or more functional tests that correspond to the updated version of the requirement information.

14. The computer-implemented method of claim 8, wherein the segmenting the first version of the requirement information into the respective portions comprise segmenting the first version of the requirement information into logical chunks having respective individual endpoints and associated data to provide contextual information to the trained model.

15. A non-transitory computer-readable medium having instructions stored thereon, wherein the instructions, when executed by at least one processor, cause at least one device to perform operations comprising:
receiving a first version of requirement information for a software application;
segmenting the first version of the requirement information into respective portions;
generating an input to a trained model based on the respective portions;
receiving and processing one or more outputs from the trained model to generate one or more functional tests that determine whether the software application satisfies the first version of the requirement information specified in the respective portions;
generating embeddings associated with the one or more functional tests; and
in response to receiving an updated version of the requirement information for the software application:
identifying one or more semantic differences between the updated version of the requirement information and the first version of the requirement information;
generating a modified input to the trained model based on the semantic differences and the embeddings associated with the one or more functional tests; and
receiving and processing one or more modified outputs from the trained model to generate one or more updated functional tests that determine whether the software application satisfies the updated version of the requirement information.

16. The non-transitory computer-readable medium of claim 15, wherein the input to the trained model comprises a prompt that causes the trained model to provide the one or more outputs to generate the one or more functional tests.

17. The non-transitory computer-readable medium of claim 15, wherein the instructions cause the at least one device to perform operations comprising receiving, after the one or more functional tests have been executed, at least one report identifying which portion of the updated version of the requirement information the software application fails to meet.

18. The non-transitory computer-readable medium of claim 17, wherein the instructions cause the at least one device to perform operations comprising parsing the at least one report to identify non-duplicated defects from the at least one report.

19. The non-transitory computer-readable medium of claim 15, wherein the embeddings associated with the one or more functional tests are stored in a vector database for retrieval.

20. The non-transitory computer-readable medium of claim 19, wherein the instructions cause the at least one device to perform operations comprising performing a semantic search on the embeddings stored in the vector database to locate relevant portions of the one or more functional tests that correspond to the updated version of the requirement information.
